(19) United States
(12) Patent Application Publication
(10) Pub. No.: US 2009/0034692 A1
(43) Pub. Date: Feb. 5, 2009

(54) WIRELESS PLAIN ORDINARY TELEPHONE SERVICE (WIRELESS POTS)

(75) Inventor: Terry Dean Drummond, Calgary (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: TELUS COMMUNICATIONS INC., Edmonton (CA)

(21) Appl. No.: 11/833,930

(22) Filed: Aug. 3, 2007

(51) Int. Cl. H04M 9/00; H04Q 7/20

(52) U.S. Cl. 379/55.1; 455/422.1

(57) ABSTRACT

A wireless plain ordinary telephone service includes a wireless interface, which provides a connection to a wireless network. A telephone dialing device sends digits corresponding to an external number into a wireless interface. An electronic line bridge lies in a wireline system. The electronic line bridge has a first line and a second line. The first line is connected to the wireless interface through a wireless network and the wireline Public Switched Telephone Network (PSTN). The second line is connected to a wireline network. The first and second lines may be connected together. The wireless terminal connects into the wireline network through the electronic line bridge and the wireless terminal sends the digits corresponding to the external number into the second line.

### BACKGROUND

Providing wireline services to all customers in a service area can be costly for service providers. For example, connecting wireline to rural customers may incur significant capital costs in order to build wireline facilities that will reach the customer. However, it may be necessary to provide wireline service to all customers within a service area. For example, regulations may require that all customers within a customer service area who request a wireline connection must be provided with a wireline connection.

### SUMMARY

There is provided in one embodiment a method of leveraging an existing cellular network as a transport medium to connect customers to a wireline network and provide plain ordinary telephone service (POTS).

In another method of providing a plain ordinary telephone service through a wireless connection, digits of a called number are collected from a customer telephone set and stored in a wireless terminal. The wireless terminal then sends preprogrammed digits of a first stage number to a cellular network via a radio frequency connection. After a predetermined period of time the stored digits of the called number are outpulsed and a transmission path to the customer telephone set is established.

In another method of providing a plain ordinary telephone service through a wireless connection there is a wireless terminal, having a two stage dialing feature, positioned at the customer residence. An electronic line bridge, installed in a wireline host switch, detects ringing from an incoming call from the wireless terminal on a first line and connects the first line and a second line together and applies a loop seizure on the second line output to connect the wireless terminal into a wireline network.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a diagram of a wireless plain ordinary telephone service with a telephone;

FIG. 2 is a diagram of a wireless plain ordinary telephone service of FIG. 2 with a computer;

FIG. 3 is a diagram of a wireless plain ordinary telephone service of FIG. 3 with a fax machine;

FIG. 4 is a diagram of an electronic line bridge in a wireless plain ordinary telephone service;

FIG. 5 is a diagram of a wireless plain ordinary telephone service in communication with the internet;

FIG. 6 is a diagram of a wireless plain ordinary telephone service in communication with an external fax machine;

FIG. 7 is a diagram of a wireless plain ordinary telephone service in communication with an external telephone;

FIG. 8 is a diagram of an electronic line bridge;

FIG. 9 is a diagram of a wireless interface;

FIG. 10 is a diagram of a wireless plain ordinary telephone service when receiving an incoming call;

FIG. 11 is a block diagram of a method of operating a wireless plain ordinary telephone service;

FIG. 12 is a block diagram of a second method of operating a wireless plain ordinary telephone service; and

FIG. 13 is a diagram of a wireless interface with a controller and memory.

### DETAILED DESCRIPTION

In the claims, the word “comprising” is used in its inclusive sense and does not exclude other elements being present. The indefinite article “a” before a claim feature does not exclude more than one of the feature being present. Each one of the individual features described here may be used in one or more embodiments and is not, by virtue only of being described here, to be construed as essential to all embodiments as defined by the claims.

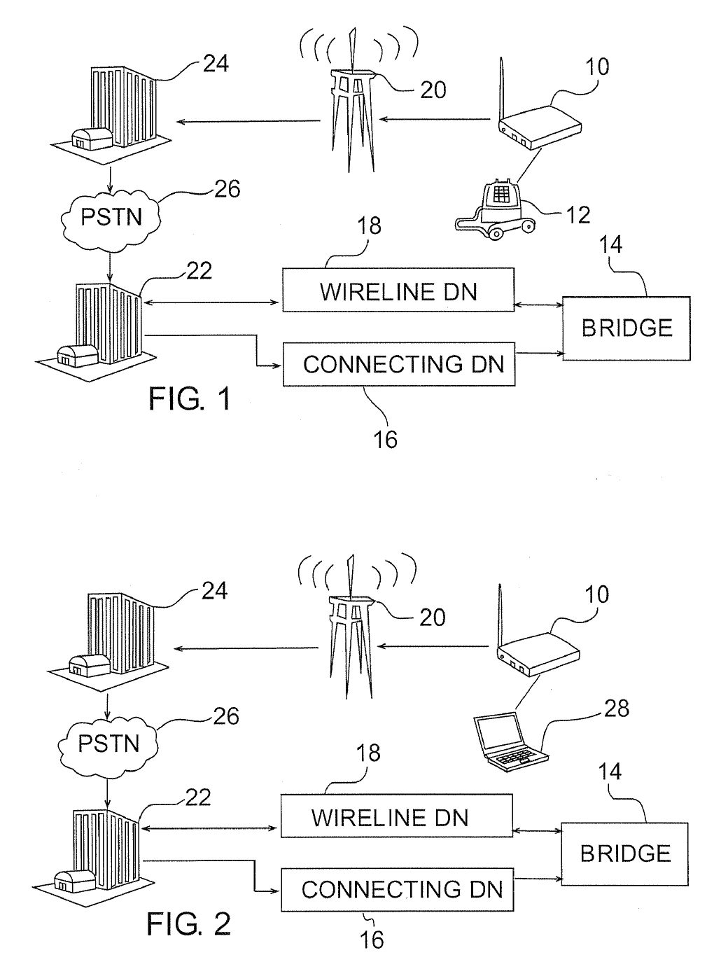

FIGS. 1-3 show a wireless plain ordinary telephone service. A wireless interface 10 is connected to a telephone dialing device. In FIG. 1 the telephone dialing device is an ordinary telephone 12, in FIG. 2 the telephone dialing device is a computer 28 and in FIG. 3 the telephone dialing device is a fax machine 30. The wireless interface 10 provides a connection to a cell site 20 in a wireless network. The telephone dialing device communicates with the wireless interface 10. An electronic line bridge 14 has a first line 16 associated with a connecting directory number and a second line 18 associated with a wireline directory number. The electronic line bridge 14 lies in a wireline system. The electronic line bridge 14 is a line within a wireline switch 22.

The first line 16 is connected to the wireless interface through a wireless network. If the wireless interface 10 dials the digits of the connecting directory number associated with the first line 16, the digits are first sent through a radio frequency (RF) connection to the cell site 20 within the wireless network. A wireless switch 24 receives the digits from the cell site 20. Through normal translations the wireless switch 24 determines that the call is destined for a wireline network and routes the call to the appropriate group trunk. The digits will then pass through the public switched telephone network (PSTN) 26 into the wireline switch 22. Through normal translations the wireline switch 22 determines that the call is destined for a line in the office and terminates the call to the connecting directory number and applies ringing current to the first line 16.

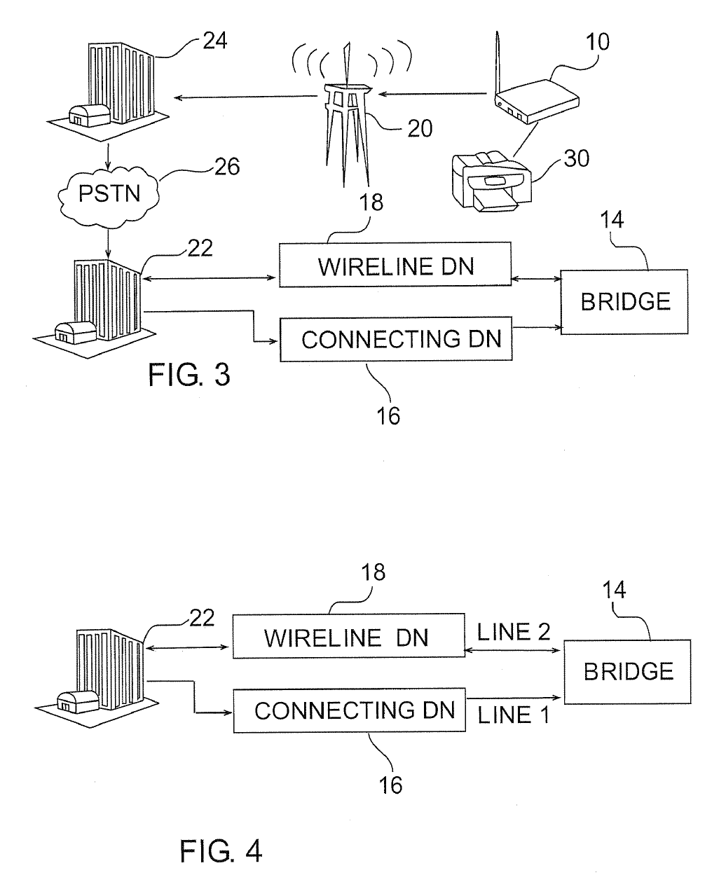

As shown in FIG. 4, the electronic line bridge 14 detects the ringing current on the first line input and immediately trips ringing and connects the first line 16 and second lines 18 together and applies a loop seizure on the second line output. The second line 18 is connected to the wireline network through the wireline switch 22. Thus, the wireless interface 10 connects into the wireline network through the electronic line bridge 14. The wireless interface 10 can connect any location within a cellular coverage footprint into the wireline system. The wireless plain ordinary telephone service can provide normal plain ordinary telephone service with no special translation or routing required in either the cellular or wireline networks and no changes required to downstream billing systems

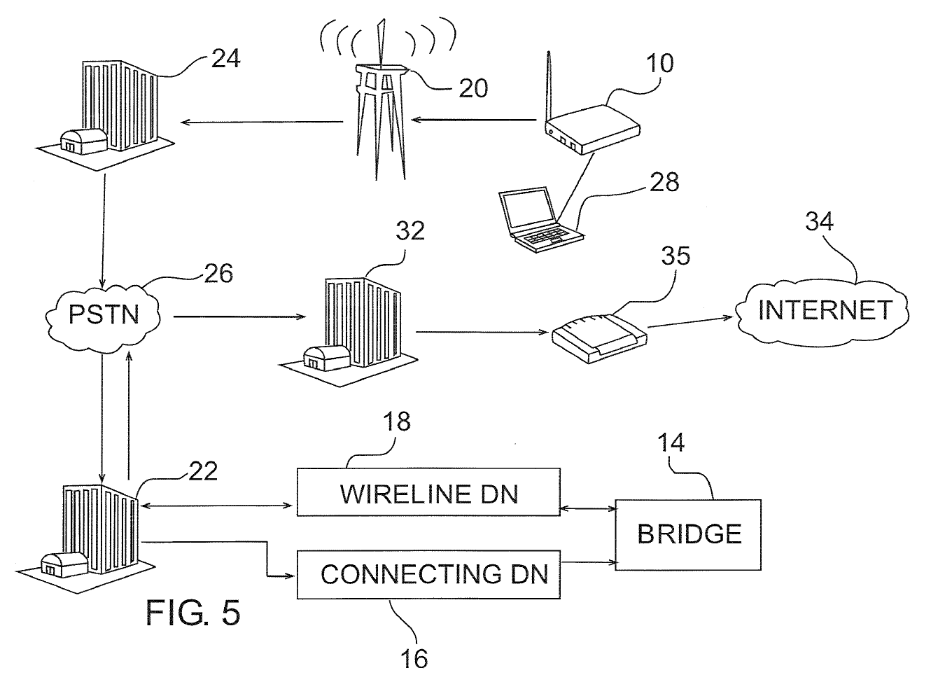

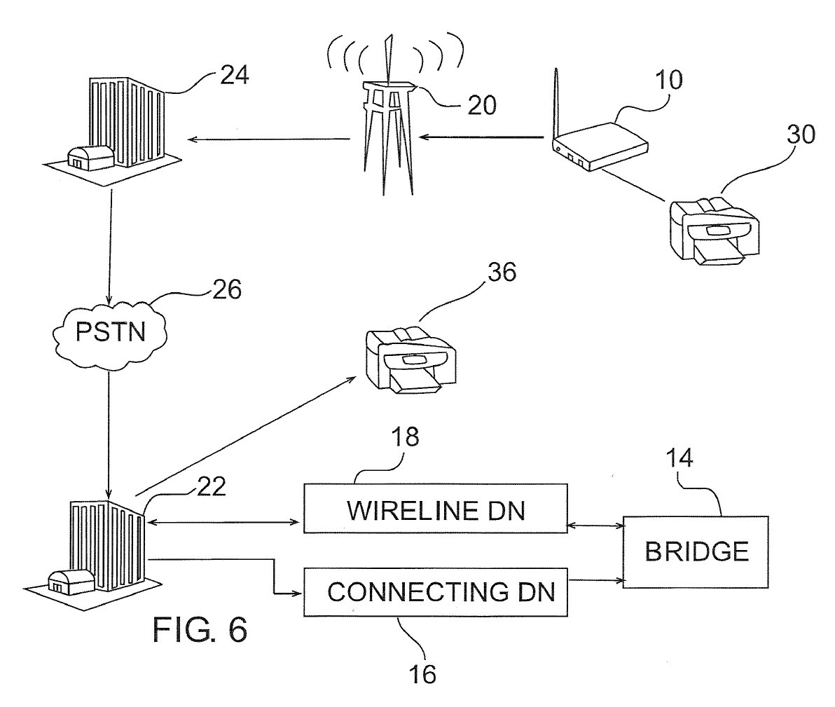

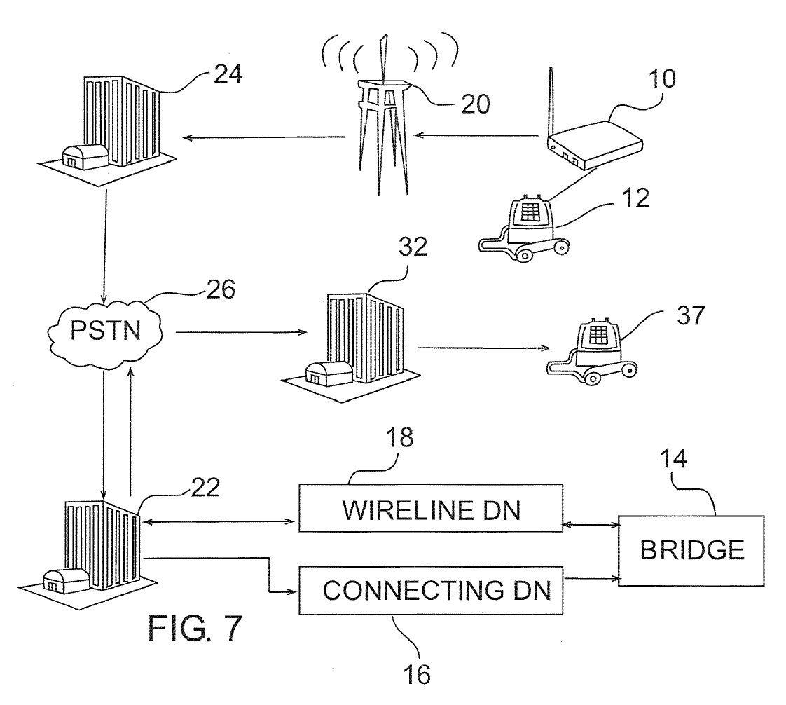

FIGS. 5-7 show the ordinary processing of a call through the second line 18 of the wireless line bridge 14 to an external connection. Once the wireless interface 10 is connected to the second line 18 of the wireless line bridge 14 the wireless interface 10 will then function as a wireline connection. Digits of a second number may then be sent to the second line 18 of the wireless line bridge 14. The digits of the second number may be entered into the telephone dialing device before or after the connection is made between the wireless interface 10 and the second line 18 of the wireless line bridge 14. The second number may be, for example, an external directory number associated with an external interface, such as an external modem 35 connected to the internet 34, an external fax machine 36 or an external telephone 37. The wireline switch 22 receives the digits associated with the external directory number and routes the call to the appropriate trunk group. As shown in FIGS. 5 and 7, after traveling through the PSTN 26, a local wireline switch 32 receives the digits and through normal translations determines the correct destination of the call. As shown in FIG. 6 the local wireline switch may be the original wireline switch 22. The call is terminated to the line and ringing current is applied to the external interface. In FIG. 5, the external modem 35 and the computer 28 successfully exchange analog data handshake tones and the Dial-Up Internet session begins. In FIG. 6, the external fax machine 36 begins sending fax tones back to the fax machine 30 and the two fax machines exchange fax handshake tones and the fax transmission is completed. In FIG. 7, the external telephone 37 is answered and the conversation proceeds.

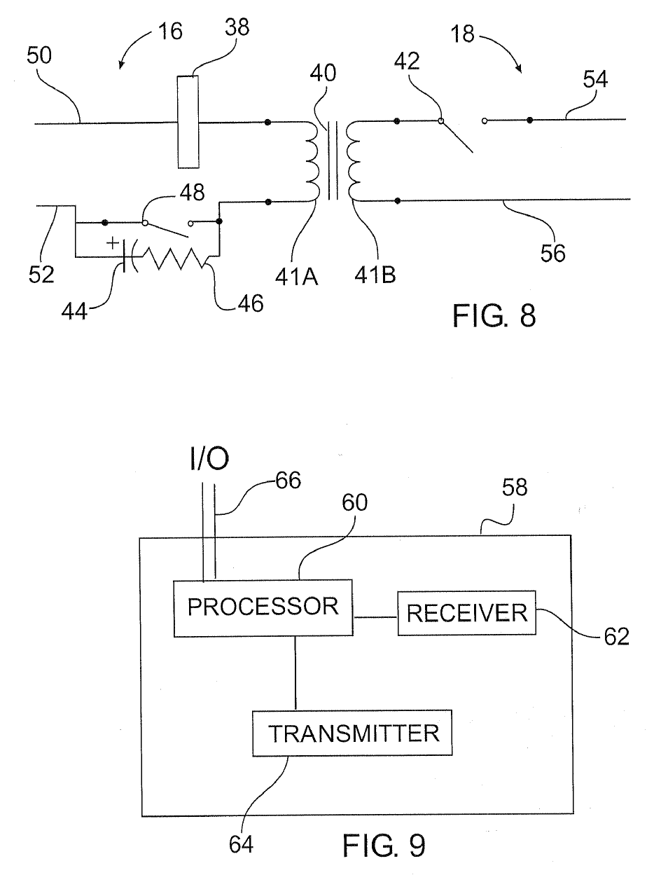

FIG. 8 shows a possible configuration of the electronic line bridge 14. When AC ringing current is applied across the tip 50 and ring 52 of the first line 16, a relay 38 operates via the path provided by an electrolytic capacitor 44, a resistor 46 and a primary winding 41A of a transformer 40. Once operated, the relay 38 locks through the relay's own contacts 48, completing a DC path between the tip 50 and ring 52 of the first line 16 to signal the wireline switch that the call is answered and to trip ringing. Once the relay 38 is locked, the relay's contacts 42 close to connect the secondary winding 41B of the transformer 40 across the tip 54 and ring 56 of the second line 18, applying a loop seizure on the second line 18 and establishing a transmission bridge between the first line 16 and the second line 18. The wireline switch recognizes the loop seizure on the second line 18 and dialtone is connected to the tip 54 and ring 56 of the second line 18, passing back to the first line 16 via the transmission bridge provided by the transformer 40.

The second number dialed from the wireless interface 10 (FIG. 1) is received as Dual Tone Multi-Frequency (DTMF) digits on the first line 16 and transmitted to the second line 18 via the transmission bridge provided by the transformer 40, breaking dialtone on the second line 18. The wireline switch collects the dialed digits from the second line 18 and the call is established over the wireline PSTN to the terminating party at the external interface. The relay 38 remains locked and the conversation between the wireless plain ordinary telephone service customer and the terminating party proceeds via the transmission bridge provided by the transformer 40. When the wireless plain ordinary telephone service customer disconnects at the conclusion of the call, the ‘Cutoff On Disconnect’ option on the first line 16 in the wireline switch momentarily removes −48V DC from the ring 52 of the first line 16, releasing the relay 38 and idling the first line 16. When relay 38 releases, the relay's contacts 42 open, which removes the loop seizure on the second line 18 and idles the second line 18.

Polarity of 44 is important in this example to ensure that the capacitor 44 does not charge to the −48V DC and ground that are normally present on the tip 50 and ring 52 of the first line 16. If the capacitor 44 polarity is reversed the relay 38 will not consistently release upon call disconnect. This circuit will not pass a hook switch flash from the originator to the second line 18.

FIG. 9 shows a diagram of a wireless interface 58. The wireless interface 58 has a processor 60 connected to a receiver 62 and a transmitter 64. Input and output wires 66 also connect to the processor 60. The input and output wires 66 connect to the telephone dialing device when the wireless interface 58 is in use. The transmitter 64 and receiver 62 send and receive signals to and from a wireless network.

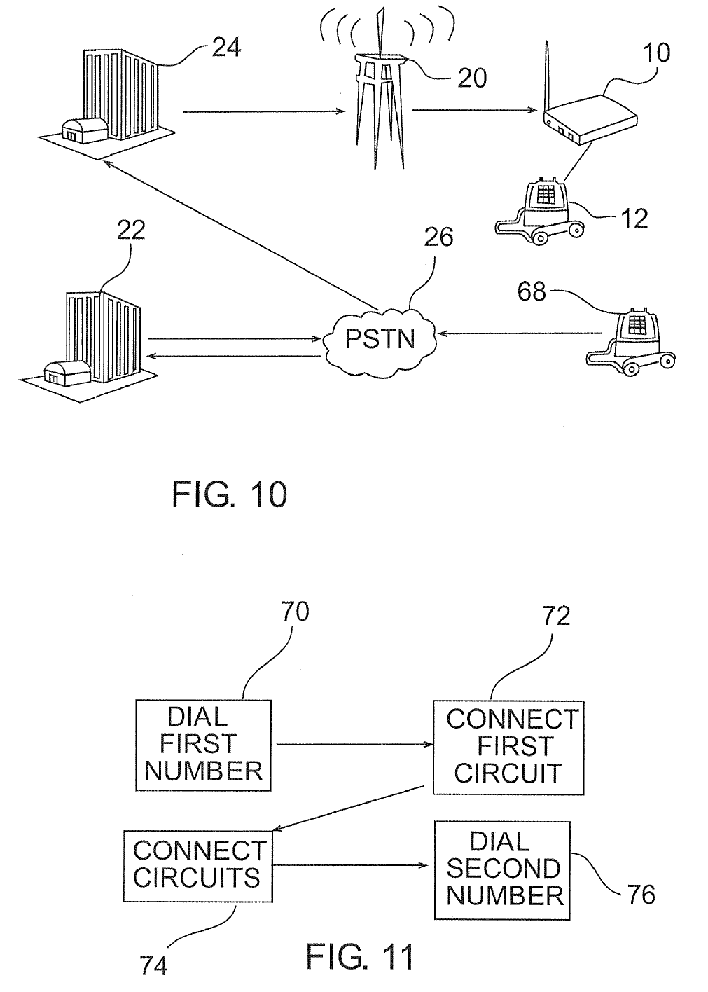

FIG. 10 shows a wireless plain ordinary telephone service configuration for an incoming terminating call. An external interface, for example an external telephone 68 is connected to the PSTN 26. The external interface 68 dials digits corresponding to the connecting directory number associated with the second line 18 (FIG. 1) of the electronic line bridge 14 (FIG. 1). The wireline switch 22 receives the dialed digits and through normal translations determines that the call is destined for a line in the office. Line datafill for the line associated with the dialed digits, however, identifies that the Fixed Call Forward option is active on this line and calls destined for the line should be forwarded to the cellular telephone number associated with wireless interface 10. The wireline switch 22 performs a normal translation on the digits associated with the wireless interface 10 and determines that the call is destined for the wireless network and connects the call through the PSTN 26 to the wireless switch 24. Through normal translations the wireless switch 24 determines that the call is destined for a cellular terminal checked into the cell site 20 and connects the call to the cell site 20. The wireless interface 10 detects an incoming cellular call and connects ringing current to the telephone 12. The call is answered and the conversation proceeds. The digits dialed by the external interface 68 need not be digits of the connecting directory number associated with the second line 18 (FIG. 1) of the electronic line bridge 14 (FIG. 1). For example, the digits dialed may be any wireline number that forwards incoming calls to the wireless interface 10.

FIG. 11 illustrates a method of connecting to a wireline network from a wireless plain ordinary telephone service. At step 70, a first number is dialed from a wireless interface 10 (FIG. 1) through a wireless network. At step 72 the wireless interface 10 (FIG. 1) is connected to a first circuit corresponding to the first number. At step 74, the first circuit is connected to a second circuit, in which the second circuit is in a wireline network. At step 76, a second number is dialed from the wireless interface 10 (FIG. 1) into the second circuit.

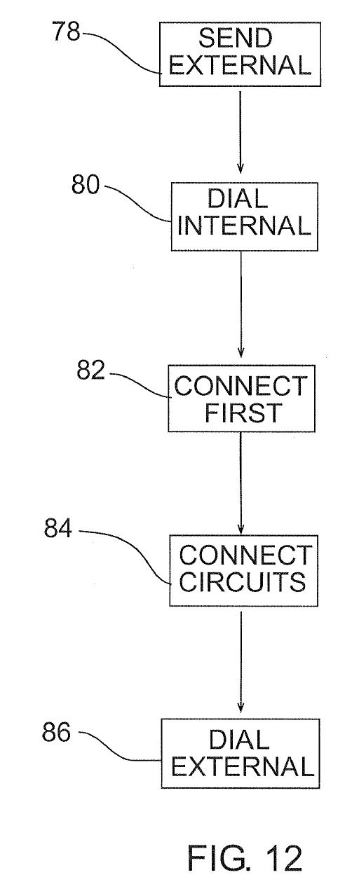

FIG. 12 illustrates another method of connecting to a wireline network from a wireless plain ordinary telephone service. At step 78, an external number is sent from a telephone dialing device, for example telephone 12 (FIG. 1), to a wireless interface 10 (FIG. 1). At step 80, an internal number is dialed from the wireless interface 10 (FIG. 1). At step 82, the wireless interface 10 (FIG. 1) is connected to a first circuit, in which the first circuit corresponding to the internal number. At step 84, the first circuit is connected to a second circuit in a wireline system. At step 84, the external number is dialed from the wireless interface 10 (FIG. 1) into the second circuit.

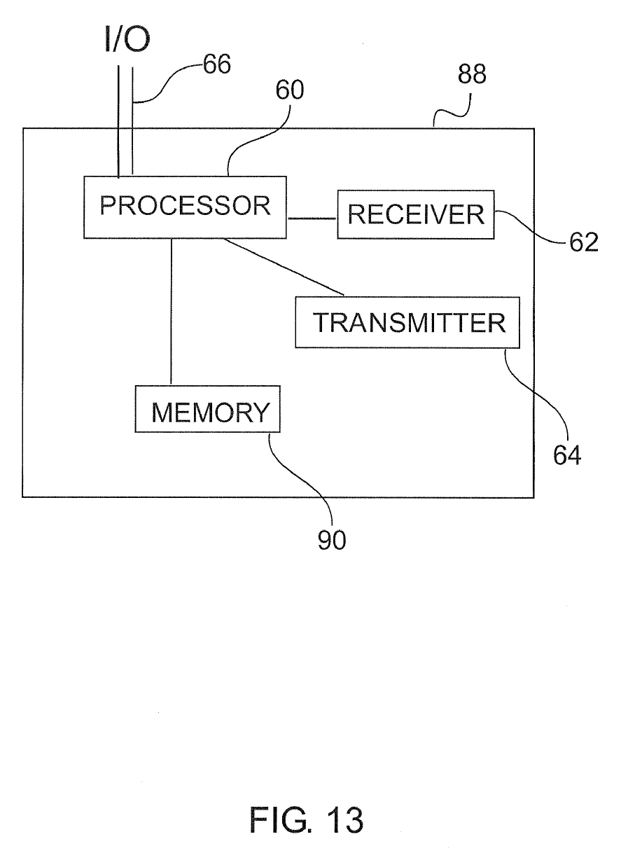

FIG. 13 shows a wireless interface having a memory 90 and an input interface 92. An interface 88 is connected to a cellular telephone network. The interface 88 contains a processor 60, receiver 62, transmitter 64 and input and output 66 as described in FIG. 9. A telephone dialing device, for example the telephone 12 in FIG. 1, is in communication with the interface 88. The processor 60 is connected to the interface 88 and the telephone dialing device. The processor 60 may be any suitable electronic processor 60 such as a chip in a general purpose computer or an application specific chip that is programmed or otherwise configured to carry out the method steps described here. The processor 60 is configured to receive a dialing signal from the telephone dialing device through the input and output 66. The processor 60 provides instructions for the interface 10 to dial a directory number stored within the memory 90. The processor 60 then waits for the interface 88 to make a connection through the cellular telephone network. After the connection is made through the cellular telephone network, the processor 60 provides instructions for the interface 88 to dial the dialing signal from the telephone dialing device.

The interface 88 may give an immediate local dialtone to the customer in response to their off hook on an analog set, for example telephone 12, connected to the interface 88. The local dialtone is turned off in response to the customer dialing the first digit of a called number and all the digits of the called number may be collected and stored in memory 90. At the conclusion of digits of the called number being collected and stored, preprogrammed digits of the first stage number may be sent to the cellular network via RF connection to the local cell site 20 (FIG. 1). The connection to the customer telephone sets may be muted and the interface 88 may time for a pre-determined period to ensure connection of the call to the first stage number has occurred. When the timing period ends, the stored digits of the called number are immediately outpulsed and the transmission path to the customer telephone set 12 is restored. The interface 88 then monitors for termination of the call by the far end or originator and processes the disconnect as usual when it occurs. The preprogrammed digits may be entered into the memory 90 from a telephone set connected to the input and output 66. A wireless interface 10 with multiple dialing modes is preferred when dialing into the electronic line bridge 14 (FIG. 1) from either the fax machine 30 (FIG. 3) or the computer 28 (FIG. 2). If multiple dialing modes are not employed, then the interface 10 may immediately enter data transmission mode when the electronic line bridge 14 (FIG. 1) automatically answers the incoming call on the first line 16 and answer supervision is returned from the first line 16 to the wireless interface 10. If the wireless interface 10 enters the data transmission mode prematurely, the transmission of touchtone digits to connect to the internet dial-up modem or external fax machine from the second line 18 (FIG. 1) may not be possible.

The first number as described in FIG. 11 or the internal number as described in FIG. 12 may be the connecting directory number associated with the first line 16 (FIG. 1) of the electronic dialing device of FIG. 1. The connecting directory number 16 may be a POTS line used only as a terminating point in the wireline network for connections established from the wireless interface 10. The POTS line may act solely as a transport medium and is invisible to customers using the wireless interface 10 and to parties calling them.

The outgoing directory number is associated with the second line 18 (FIG. 1) of the electronic line bridge 14 (FIG. 1). The outgoing directory number is the source of the wireline network dialtone provided to the wireless POTS customer when the customer goes offhook to originate a call and a connection is made to the electronic line bridge 14 (FIG. 1). The wireless POTS customer should receive a wireline bill for the outgoing directory number associated with the second line 18 (FIG. 1) rather than a wireless bill for the directory number associated with the wireless interface 10 (FIG. 1). All callers to the wireless POTS customer contact the wireless POTS customer by dialing the outgoing directory number associated with the second line 18 (FIG. 1). Also, the outgoing directory number associated with the second line 18 (FIG. 1) is the number listed for the wireless POTS customer in the local directory. To provide basic call processing functionality for the wireless POTS line, the second line 18 (FIG. 1) is datafilled to permanently call forward incoming calls to the wireless interface 10 (FIG. 1).

A cellular number is assigned to the wireless interface 10 (FIG. 1). To provide a wireline network dialtone the wireless interface 10 (FIG. 1) may be automatically programmed to dial the number associated with the first line 16 (FIG. 1) of the electronic line bridge 14 (FIG. 1) one second after the wireless POTS customer goes offhook on the telephone 12 (FIG. 1) connected to the wireless interface 10 (FIG. 1).

One configuration of the electronic line bridge 14 shown in FIG. 8 will now be described. The relay 38 may be a DIP PCB Mount Relay with a 62Ω coil. The capacitor 44 may be a 470μ 63V Electrolytic Capacitor. The resistor 46 may be a 3.3 KΩ ¼ W 10% resistor. The transformer 40 may be a 600Ω PCB Mount Audio Transformer.

The telephone dialing device and the wireless interface 10 of FIG. 1 are shown as two separate entities. However, the components of the two systems may be combined together in a single device such as a cellular telephone. The cellular telephone may have an added feature to include multiple stage dialing. The FIGS. 1-7 show embodiments of a wireless network and a wireline network. A person of ordinary skill in the art would realize that different wireless networks and different wireline networks may have different configurations and different components than those that are shown. The electronic line bridge 14 (FIG. 1) is an example of an apparatus which may be used to connect two lines within a wireline network. A different apparatus may be employed to carry out the steps of the method described without departing from what is covered by the claims. The wireless plain ordinary telephone service provides most of the features of a normal wireline connection, including for example, E911, call tracing, voice mail, and other wireline services.

Immaterial modifications may be made to the embodiments described here without departing from what is covered by the claims.

What is claimed is:

1. A method of providing a plain ordinary telephone service through a wireless connection, the method comprising the steps of:
dialing a first number from a wireless interface through a wireless network;
connecting the wireless interface to a first circuit corresponding to the first number;
connecting the first circuit to a second circuit, the second circuit being in a wireline network; and
dialing a second number from the wireless interface into the second circuit.

2. The method of claim 1 in which connecting the first circuit to a second circuit comprises bridging the first circuit into the second circuit.

3. The method of claim 2 in which bridging the first circuit into the second circuit further comprises applying a loop seizure on an electronic line bridge between the first circuit and the second circuit.

4. The method of claim 2 in which the wireless interface is connected to a telephone dialing device.

5. The method of claim 4 in which the telephone dialing device is a telephone, fax machine, personal computer, or other communication device normally connected to a line on the wireline Public Switched Telephone Network (PSTN).

6. The method of claim 2 in which
the wireless interface stores the first number;
the telephone dialing device provides the second number to the wireless interface; and
the wireless interface dials the first number after receiving the second number from the telephone dialing device.

7. The method of claim 1 further comprising the step of arranging a billing system so that calls originating at the wireless interface are billed as calls originating from the second circuit.

8. A method of providing a plain ordinary telephone service, the method comprising the steps of:
sending an external number from a telephone dialing device to a wireless interface;
dialing an internal number from the wireless interface;
connecting the wireless interface to a first circuit, the first circuit corresponding to the internal number;
connecting the first circuit to a second circuit in a wireline system; and
dialing the external number from the wireless interface into the second circuit.

9. The method of claim 8 in which the internal number is stored within the wireless interface.

10. The method of claim 8 in which connecting the first circuit to the second circuit comprises bridging the first circuit into the second circuit.

11. The method of claim 10 in which an electronic line bridge connects the first circuit to the second circuit and in which bridging the first circuit to the second circuit further comprises applying a loop seizure on the electronic line bridge.

12. A wireless plain ordinary telephone service, comprising:
a wireless interface providing a connection to a wireless network;
a telephone dialing device operably connected to the wireless interface;
an electronic line bridge in a wireline system, the electronic line bridge having a first line and a second line, the first line being connected to the wireless interface through a connection across the Public Switch Telephone Network and cellular network and the second line being connected to a wireline network, the wireless terminal connecting into the wireline network through the electronic line bridge.

13. The wireless plain ordinary telephone service of claim 12 in which the telephone dialing device is a telephone, fax machine, personal computer, or other communication device normally connected to a line on the wireline Public Switched Telephone Network (PSTN).

14. The wireless plain ordinary telephone service of claim 12 in which in operation the wireless interface dials into the electronic line bridge through the wireless network and the wireless interface dials an external number when a connection is established between the wireless terminal and the electronic line bridge.

15. The wireless plain ordinary telephone service of claim 14 further comprising an external interface and in which the external number is a directory number associated with the external interface and a connection is established between the wireless interface and the external interface.

16. The wireless plain ordinary telephone service of claim 15 in which the wireless interface is associated with a wireless number and the electronic line bridge is associated with a landline number, and a billing system bills connections made between the wireless interface and the external interface as connections made between the landline number associated with the electronic line bridge and the external interface.

17. The wireless plain ordinary telephone service of claim 13 in which the wireless interface is located at a remote site.

18. The wireless plain ordinary telephone service of claim 17 in which the remote site is a rural or urban location.

19. A communication service, comprising:
an interface connected to a cellular telephone network;
a telephone dialing device in communication with the interface; and
the interface configured to:
receive a dialing signal from the telephone dialing device;
provide instructions for the interface to dial a stored directory number;
wait for the interface to make a connection through the cellular telephone network; and
provide instructions for the interface to dial the dialing signal from the telephone dialing device.
